(19) United States
(12) Patent Application Publication
(10) Pub. No.: US 2026/0241882 A1
(43) Pub. Date: Aug. 20, 2026

(54) Cover Part for a Bumper of a Motor Vehicle

(71) Applicant: Mercedes-Benz Group AG, Stuttgart (DE)

(72) Inventors: Peter SCHMITZ, Aidlingen (DE); Marius SILLMANN, Boeblingen (DE); Matthias SCHEFFZUEK, Ammerbuch (DE)

(21) Appl. No.: 19/164,756

(22) PCT Filed: Mar. 8, 2024
(86) PCT No.: PCT/EP2024/056131

§ 371 Date: Sep. 12, 2025

(30) Foreign Application Priority Data
Mar. 13, 2023 (DE) 10 2023 000 968.7

(51) Int. Cl. B60R 19/18; B60R 19/50

(52) U.S. Cl. CPC B60R 19/18; B60R 19/50; B60R 2019/1886; B60R 2019/505

(57) ABSTRACT

A cover part for a bumper of a motor vehicle includes an outer component and an inner component where the outer component and the inner component are plastic and are connected to each other at least in a connection region. The inner component has a first wall region and a second wall region where the second wall region is more flexible than the first wall region.

### BACKGROUND AND SUMMARY OF THE INVENTION

The invention relates to a cover part for a bumper of a motor vehicle.

Such a cover part is used, for example, as a central front cover part of a bumper cover of the bumper, in particular on electrically powered motor vehicles. In this case, the cover part usually has an outer component forming the outer skin of the vehicle and an inner component, each of which is made of plastic and connected to each other at least in a connection region.

In particular, in the connection region of the two components, there can be a considerable increase in the rigidity, especially the bending rigidity, of the overall component or the cover part, which can lead to high loads on a person who has been hit in pedestrian protection load cases.

The object of the present invention is thus to create a cover part having a degree of rigidity, in particular bending rigidity, which is reduced at least in regions.

The cover part according to the invention comprises an outer component, in particular and preferably forming the outer skin of the motor vehicle, and a component arranged on the inside thereof, which is at least partially covered by the outer component. Both components are formed from a respective, possibly different plastic and are connected to each other at least in a connection region.

In order to create a cover part whose rigidity, in particular bending rigidity, is reduced at least in some regions, the inner component according to the invention has a first wall region and a second wall region that is designed to be more flexible in comparison. This allows the inner component to be designed to be flexible at specific points, such that the connection region between the two components in particular is not excessively rigid. As a result, the inner component has the more flexible second wall region, particularly in the connection region with the outer component, or the more flexible wall region at least partially forms the connection region of the inner component such that its rigidity in the connection region is specifically reduced. As a result, a targeted reduction or weakening of the rigidity, in particular the bending rigidity, of the overall component or the cover part is achieved, in particular in the connection region of the two components, but also at other points of the inner component if necessary, such that in pedestrian protection load cases, the person who has been hit is only subjected to a reduced load. The outer component, on the other hand, ensures that the cover part has sufficient rigidity during vehicle operation to withstand the usual operational loads.

In a further embodiment of the invention, the outer and inner components delimit a receiving space such that, at least in some regions, the cover part has a box shape when viewed in cross-section, with the components being spaced apart from each other in at least some regions. In order to specifically reduce the rigidity of the box shape of the cover part, particularly in the connection region of the two components, the flexibility according to the invention of the second wall region of the inner component, preferably in the connection region with the outer component, is provided.

Furthermore, it has proven advantageous if the outer component and the inner component are tightly connected to each other along a circumferential connection region to form a sealed receiving space. In other words, the inner component in particular is designed with the respective wall regions of different degrees of flexibility in such a way that a tight connection between the two components is achieved in the connection region, especially when the flexible wall region of the inner component forms the connection region with the outer component.

Another advantageous design of the invention provides that the more flexible second wall region of the inner component is at least partially provided in its connection region with the outer component. This results in a particularly favorable reduction in the rigidity of the cover part in the connection region of the two components with regards to pedestrian protection.

It is also advantageous if the more flexible second wall region forms an at least substantially flat surface area of the inner component. This also allows the rigidity of the cover part to be specifically reduced with regards to pedestrian protection.

In a further embodiment of the invention, the first and second wall regions of the inner component are manufactured using a two-component injection moulding process. This two-component injection moulding process makes it particularly easy and cost-effective to manufacture the inner component.

Finally, it is advantageous if the outer component is designed as an at least partially transparent front panel. This allows a corresponding lighting device to be integrated into the receiving space, which is preferably sealed, and the front of the vehicle to be illuminated.

Further advantages, features and details of the invention emerge from the following description of a preferred exemplary embodiment and from the drawings. The features and combinations of features mentioned in the description above and the features and combinations of features mentioned in the description of figures below and/or only shown in the figures can be used not only in the combination indicated in each case, but also in other combinations or on their own without leaving the scope of the invention.

### BRIEF DESCRIPTION OF THE DRAWINGS

FIGS. 1a, 1b, and 1c show a perspective rear view, a perspective sectional view along a center plane of the motor vehicle running in the vertical and longitudinal directions of the vehicle, and an enlarged perspective sectional view through a bumper arrangement for a passenger car having a bumper, in the bumper cover of which a cover part according to the invention is integrated;

FIG. 2 is a sectional view along a center plane of the motor vehicle running in the vertical and longitudinal directions of the vehicle through the bumper arrangement with the cover part integrated into the bumper cover in an operating position;

FIG. 3 is a sectional view along a center plane of the motor vehicle running in the vertical and longitudinal directions of the vehicle through the bumper arrangement with the cover part integrated into the bumper cover in a position shifted rearward due to an accident;

FIG. 4 is a rear view of the cover part of the bumper cover; and

FIG. 5 is a sectional view along a sectional plane running in the vertical and longitudinal directions of the vehicle through the cover part according to FIG. 4, shown by line V-V.

### DETAILED DESCRIPTION OF THE DRAWINGS

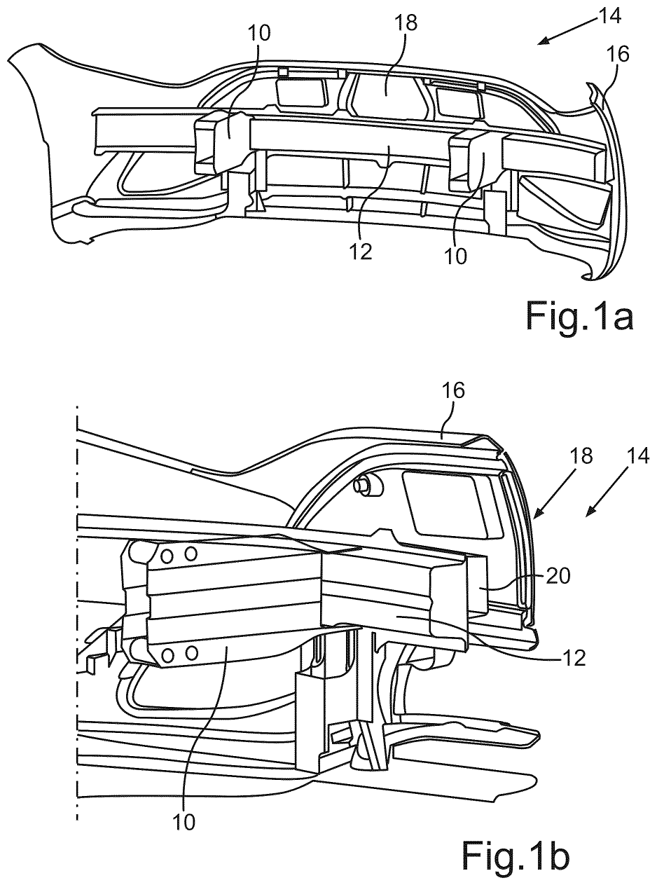

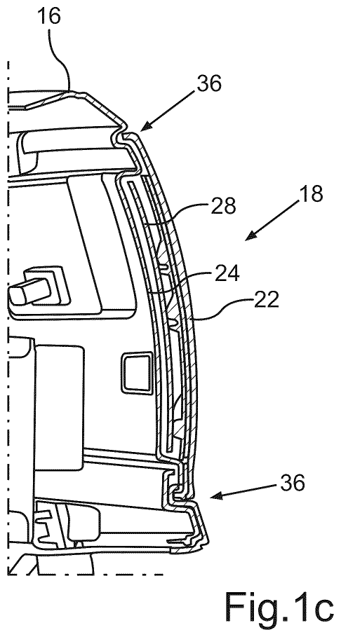

FIG. 1a shows a perspective rear view of a bumper arrangement for a passenger car, which is operated in particular by an electric drive. Two energy absorption elements 10, also known as crash boxes, are particularly noticeable. These are connected at one end to the main longitudinal members of a front structure of the motor vehicle, and a bumper cross member 12 extends horizontally in the transverse direction of the vehicle at their front ends.

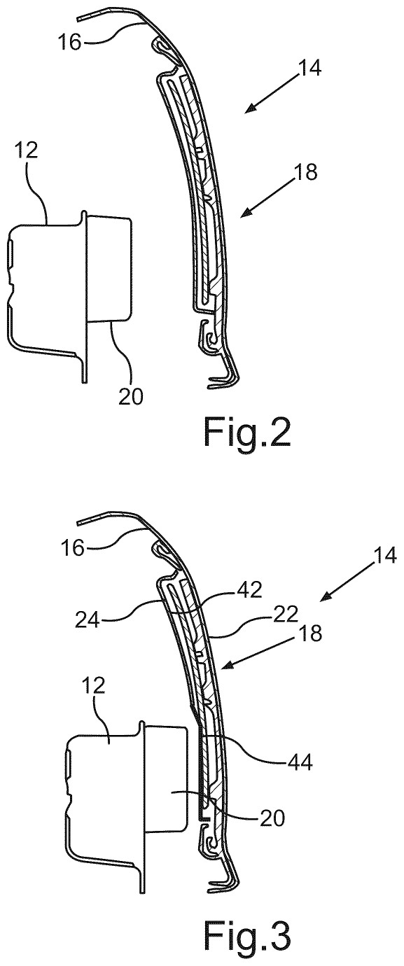

A bumper 14 is held at the front of the motor vehicle by means of a base carrier, which comprises a bumper cover 16. In a central upper region, the bumper cover 16 of the bumper 14 comprises a cover part 18, which in the present case—as can be seen in FIG. 1b in a perspective sectional view along a center plane of the motor vehicle running in the vertical and longitudinal direction of the vehicle and in FIG. 1c in a perspective sectional view enlarged in relation to FIG. 1b—is designed in the form of a housing space for accommodating a lighting device 28. The design of the cover part 18, which in the present case is illuminated, for example, as an indication of the electric drive of the vehicle, will be explained in more detail below with reference to FIGS. 2 and 5.

In conjunction with FIGS. 2 and 3, which each show a sectional view along a center plane of the motor vehicle running in the vertical and longitudinal directions of the vehicle through the bumper arrangement with the cover part 18 integrated into the bumper cover 17, it can initially be seen that a limiting part 20 is arranged and supported at the front of the bumper cross member 12. This limiting part 20 extends, for example, over the entire length or width of the cover part 18 in the transverse direction of the vehicle. The limiting part 20, also referred to as a pendulum stopper, can be used to limit the accident-related rearward displacement of the cover part 18 indicated in FIG. 3. The use of the pendulum stopper makes it possible to achieve a sufficiently high degree of rigidity and, for example, to slow down or stop collision objects other than pedestrians that collide with the bumper cover 16. This allows objects simulated by a pendulum, for example, that collide with the bumper cover to be stopped in order to prevent excessive intrusion into the front end of the motor vehicle. The bumper cover 16 with the cover part 18 is arranged at a distance in front of the bumper cross member 12 and the limiting part 20.

The cover part 18 comprises a front or outer component 22 in the form of a front panel, which is made of a partially transparent plastic, for example. The front panel forms a sealed receiving space 26 together with an inner component 24 of the cover part 18, within which a lighting device 28 is arranged. The outer component 22, i.e., the front panel, and the inner component 24 are connected to each other via a plug connection 30 with a plug part 32 on the front panel side and a receiving groove 34 with an approximately C-shaped cross-section on the inner component 24 side in a connection region 36 running around the outer circumference.

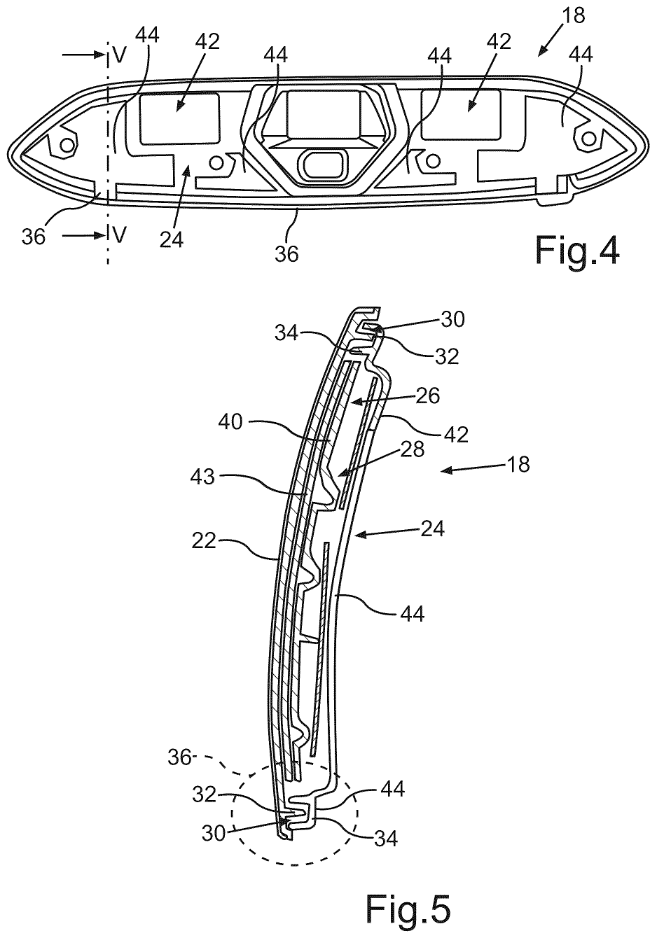

This connection region 36, which runs around the outer circumference, is clearly visible in FIG. 4, in which the cover part 18 is depicted in a rear view from back to front or from the interior of the motor vehicle towards the outside.

According to FIG. 5, which shows the cover part 18 in a sectional view along a sectional plane, shown by the line V-V, running in the vertical and longitudinal direction of the vehicle through the cover part 18 according to FIG. 4, it can in particular be seen that the lighting device 28 is arranged within the receiving space 26. This comprises, in particular, a reflector 40, within which light elements, in particular LEDs (Light Emitting Diodes), are arranged, as well as a cover layer 43 designed as a diffuser, which is arranged behind the outer component 22/front panel. The front panel is also designed to be transparent in at least some regions such that the light from the LEDs is visible from the front.

As shown in an overview of FIGS. 4 and 5, the inner component 24 has at least one, in this case several, first wall regions 42 and at least one, in this case also several, second wall regions 44 that are designed to be more flexible in comparison. As can be seen in particular from FIG. 5, the more flexible second wall region 44 of the inner component 24 is provided at least partially in the lower region of the connection region 36 with the outer component 22. In particular, the C-shaped receiving groove 34 on the side of the inner component 24, which forms a plug connection 30 with a plug part 32 on the side of the front panel, is partially created on the underside by the more flexible second wall region 44 of the inner component 24. It can also be seen that the respective first wall regions 42 and more flexible second wall regions 44 form respective, at least substantially flat, surface areas of the inner component 24. The first and second wall regions 42, 44 of the inner component 24 are, in particular, made of a respective plastic in a two-component injection moulding process. The outer component 22, i.e., the front panel, is also made of plastic.

It can thus be seen that the two components 22, 24 of the cover part 18 are tightly connected to each other in a circumferential connection region 36 in order to form the sealed receiving space 26 for the lighting device 28. If the cover part 18 is displaced rearwardly from the operating position shown in FIG. 2 as a result of a pedestrian impact and comes into contact, for example, with the limiting part 20 as shown in FIG. 3, the flexible design of the at least one second wall region 44 of the inner component 24 ensures that the cover part 18 does not exhibit excessive rigidity, but rather yields in a targeted manner. This prevents excessive force being exerted on the pedestrian as a result of excessive rigidity of the cover part 18.

Looking at FIGS. 2 and 3, it can be seen that the necessary clearance, i.e., the distance between the limiting part 20 and the inner component 24, for pedestrian protection is increased by using a soft material for the cover part 18. In the event of a load, the housing of the cover part 18 therefore yields even under low loads. This can be applied to any component in this load range that consists of several components, of which not all sub-components need to be rigid.

1-7. (canceled)

8. A cover part (18) for a bumper (14) of a motor vehicle, comprising:
an outer component (22) and an inner component (24), wherein the outer component (22) and the inner component (24) are plastic and are connected to each other at least in a connection region (36);
wherein the inner component (24) has a first wall region (42) and a second wall region and wherein the second wall region is more flexible than the first wall region (42).

9. The cover part (18) according to claim 8, wherein the outer component (22) and the inner component (24) delimit a receiving space (26).

10. The cover part (18) according to claim 9, wherein the connection region (36) is circumferential, wherein the receiving space (26) is sealed, and wherein the outer component (22) and the inner component (24) are connected to each other in a sealed manner along the circumferential connection region (36) and form the sealed receiving space (26).

11. The cover part (18) according to claim 8, wherein the second wall region is provided at least partially in a lower region of the connection region (36) with the outer component (22).

12. The cover part (18) according to claim 8, wherein the second wall region forms a flat surface area of the inner component (24).

13. The cover part (18) according to claim 8, wherein the first wall region (42) and the second wall region are manufactured in a two-component injection moulding process.

14. The cover part (18) according to claim 8, wherein the outer component (24) is an at least partially transparent front panel.
